(19) United States
(12) Patent Application Publication
(10) Pub. No.: US 2001/0039762 A1
(43) Pub. Date: Nov. 15, 2001

(54) Spring operated device for door movement, having an adjustable lever arm of the spring

(76) Inventor: Antonio Giovannetti, Milan (IT)

Correspondence Address: JACOBSON HOLMAN PLLC, 400 SEVENTH STREET N.W., SUITE 600, WASHINGTON, DC, 20004, US

(21) Appl. No.: 09/842,170

(22) Filed: Apr. 26, 2001

(30) Foreign Application Priority Data
May 12, 2000 (EP) 00830344.8

(51) Int. Cl. E05D 15/28

(52) U.S. Cl. 49/246

(57) ABSTRACT

A movement device for pieces of furniture, for articulating a door with respect to a stationary structure, comprises a first articulation element (12; 12a . . . ) linked to the door and pivotable with respect to the stationary structure, and a second articulation element (14) hinged to the stationary structure, the ends of said two articulation elements being hinged together, the first articulation element having an elastically variable extension, so that said two elements may assume with respect to one another a stable retracted position and a stable extended position, passing through a succession of unstable positions, and further comprises adjusting means (30; 30a; 30b . . . ) for adjusting the distance between an axis (a16) of the hinge between the two elements and a rotation axis (a13) of the second element with respect to the stationary structure.

### DESCRIPTION

The invention refers to a movement device for doors in the furnishing field, particularly doors for furniture, as are used, for example, in kitchen furniture or the like. In particular, reference is made to doors that are movable with respect to a stationary structure by means of a so-called “overcentre” mechanism, which comprises a first articulation element or connecting rod or link, in the form of a pressure spring, pivoted with one end thereof at a stationary position on the stationary structure, and a second element or connecting rod or link pivoted with one end thereof on the same stationary structure, the two elements being hingedly connected together at a second end of each of them. The first element is comprised of a spring, preferably a gas spring. The second element is linked directly to the movable door or is a part thereof, or else is linked to a movable door through a four-bar linkage device. The movement device is stable in two end positions, a retracted, closed-door end, position and an extracted, open-door, end position, and passes from one to the other stable position through a series of unstable positions which comprise a position of alignment of the two connecting-rod elements, or “dead centre”.

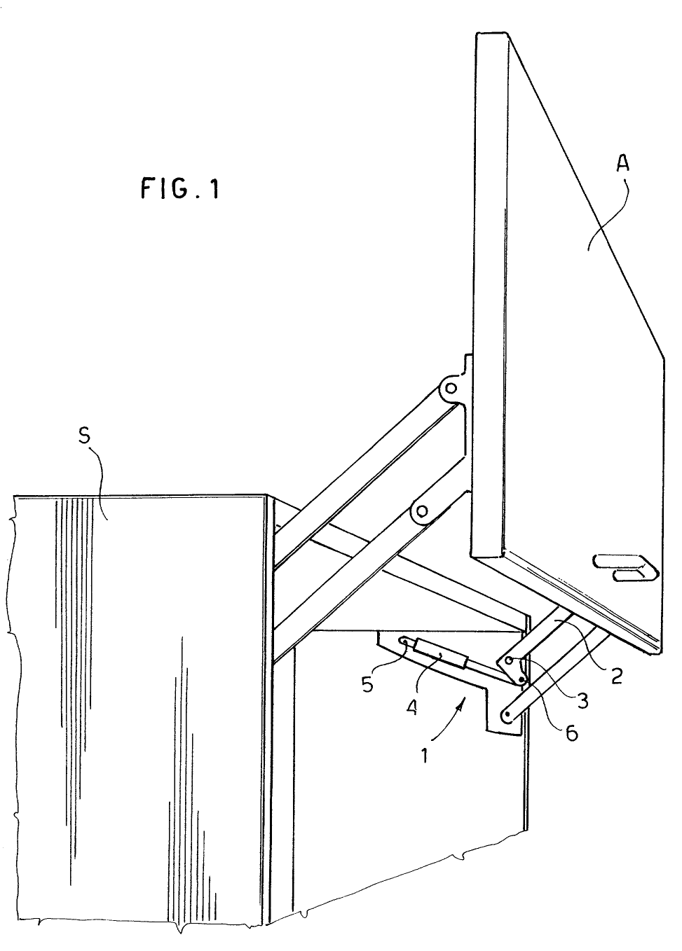

Mechanisms of the above-mentioned type are well known for opening of doors. Such a mechanism is shown in FIG. 1, in which S is a stationary structure, A is a movable door and 1 is a prior art device for door movement. The device comprises an articulation element 2 (lever or connecting rod) which, in the case, is part of a four-bar linkage and is hinged in a stationary point or fulcrum 3 on a plate fixed to the stationary structure S. An articulation element or connecting rod 4 is hinged in a stationary point 5 to the stationary structure, whilst at the other end it is hinged in a point 6 to an extension of element 2. Element 4 is generally comprised of a gas spring or gas-controlled spring, even though a pressure spring of a helical type may possibly be used. The spring-connecting rod 4 biased element 2 in one or other of two stable end-of-travel positions; namely, an open or extended position, shown in FIG. 1, in which the pivoting point 6 is set beneath the pin 3 of the lever or element 2, and a retracted position (not shown) in which the pin 6 is biased above the position 3. The connecting rod 4 and the lever 2 pass from the extended (stable) position to the retracted (stable) position, and vice versa, by means of rotation of the point 6 about the pin 3, through a series of unstable positions. The movement from one position to the other is caused by the action of the user on door A.

The device shown in FIG. 1 requires the spring (or springs, in the case where there are a number of devices for each door) to be exactly calibrated for the weight of a door. Since the weight of the doors can vary even considerably in one and the same set of furniture, according, for example, to the width of the doors, it is necessary for the furniture manufacturer to keep a large number of gas springs in stock. In addition, doors of a same size may have different weights, and this problem is unlikely to solve. Gas springs generally used for this purpose are not adjustable.

A further drawback is that, in time, gas springs may lose their strength.

An aim of the invention is to enable spring operation adjustment in a device for door movement, both in order to reduce the number of the springs to be kept in stock for a given set of furniture, and to enable adjustment in time. A further aim is to enable such an adjustment with easily accessible means. An additional aim is to obtain the said adjustment without intervening directly on the spring, which can thus be acquired standard on the market without any need for further interventions.

The above aims are achieved with a device as specified in claim 1. Further characteristics and advantages emerge from the dependent claims.

In other words, the new device for door movement comprises a first element pivoted at one end to a stationary structure and generally consisting of a gas-controlled spring, and a second element pivoted to the stationary structure, in a position different from that of the first element, the two elements being hingedly linked together, a hinge or pivot point of the two elements being adjustable in position for a length by means accessible from outside. In one embodiment the second element comprises a casing, which forms a housing for a movable adjusting pawl on which is pivoted a head of the first element, and the adjusting pawl may be adjusted in position by means of a threaded stem which is rotatably housed inside the casing. The threaded stem has a means for being accessible from outside, for example a knurled head, a ring gear, or a bevel gear pair. Alternatively, a threaded stem may be screwed in a threaded hole of the casing and may carry directly an end or head of the spring element. In any case, a position-adjusting means engages an end of the first element (generally the head of the stem of the spring) and the casing in order to vary their mutual positions.

The new device enables the use of a gas spring of one and the same size for doors weights within a certain range and hence enables reduction of warehouse stocks. In addition, by varying the lever arm of the point of action of the head of the stem of the spring, it enables compensation of any decrease of the spring bias over time.

Exemplary of embodiments of the invention will be described in the following with reference to the attached drawings, in which:

FIG. 1 is a broken-away perspective view of a piece of furniture provided with openable doors on an articulated-parallelogram support, with a door movement device according to the state of the art;

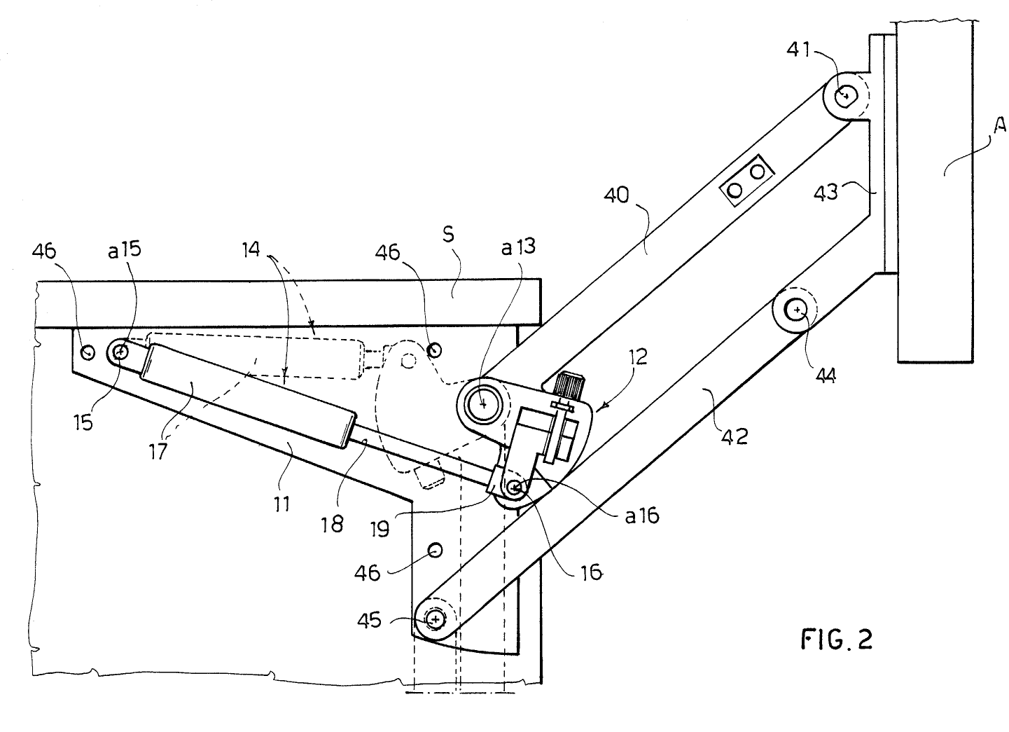

FIG. 2 shows a device according to the invention, in a side view similar to that of FIG. 1, with a cover or guard removed, in an open door condition;

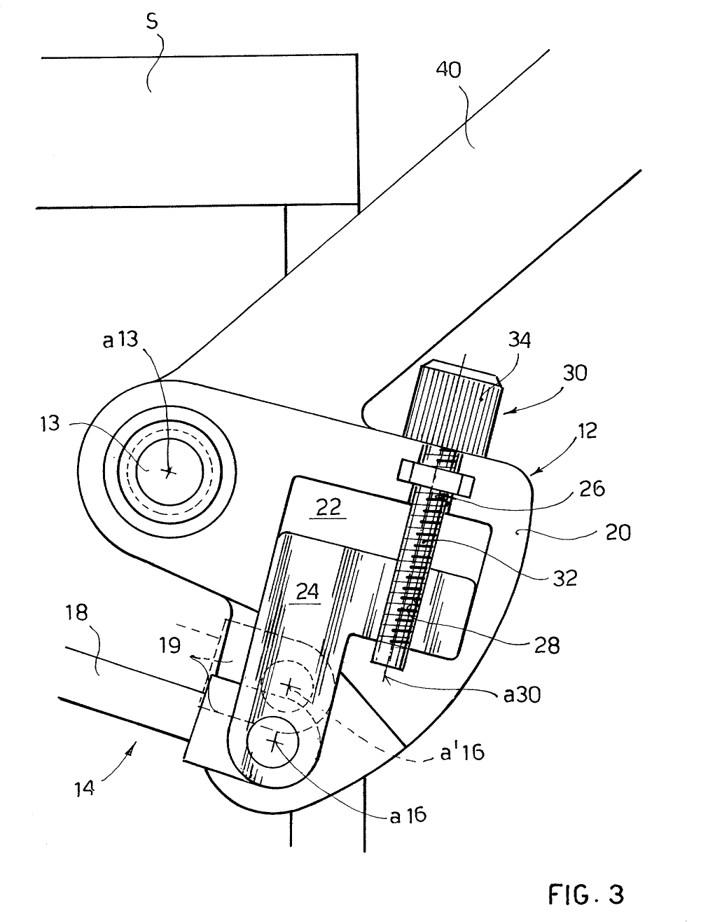

FIG. 3 shows an enlarged part of FIG. 1;

FIG. 3a shows a face opposite to that of FIG. 3;

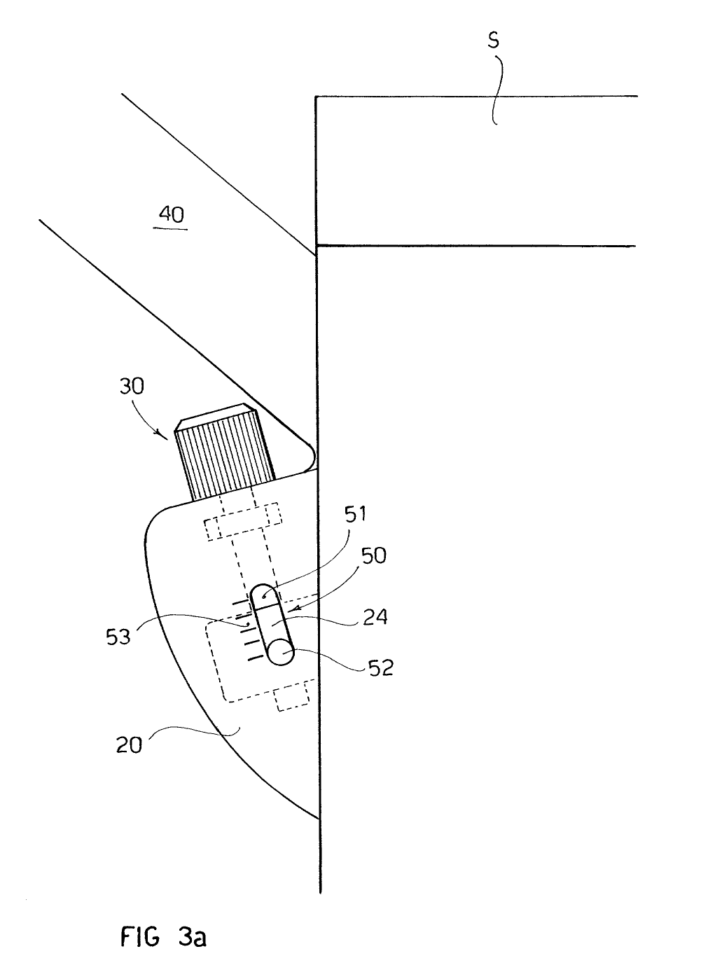

FIG. 4 shows a modified embodiment of the device, in which an adjusting stem is operated by means of a bevel gear pair accessible from outside;

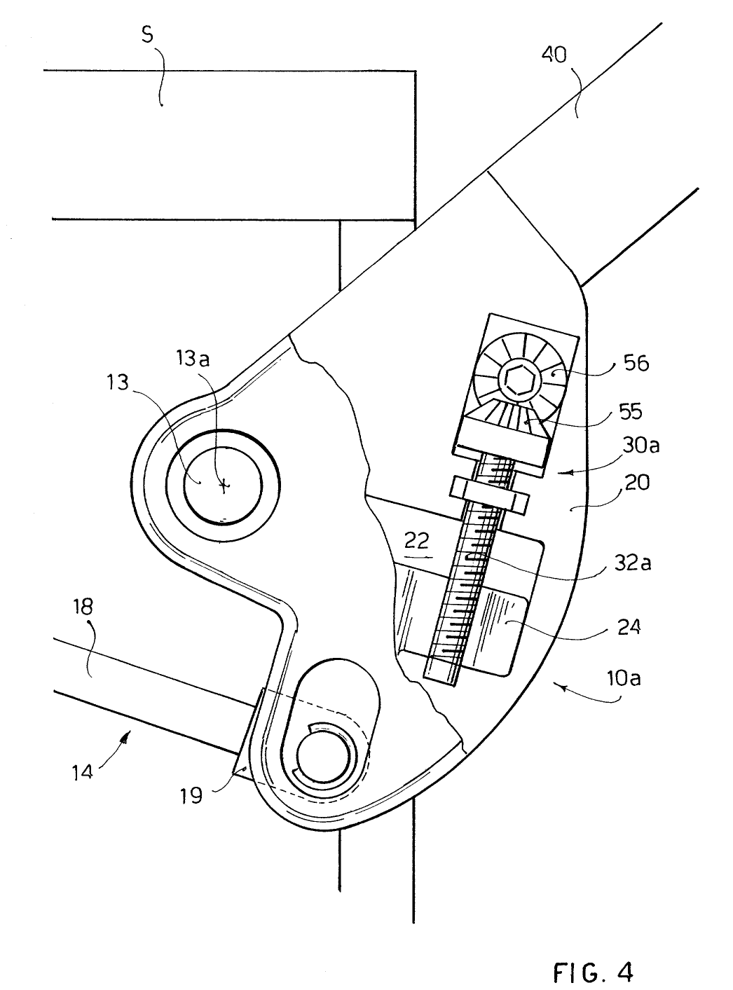

FIG. 5 shows a modified embodiment, represented as in FIG. 3, in which an adjusting stem is integral with a ring gear accessible from outside;

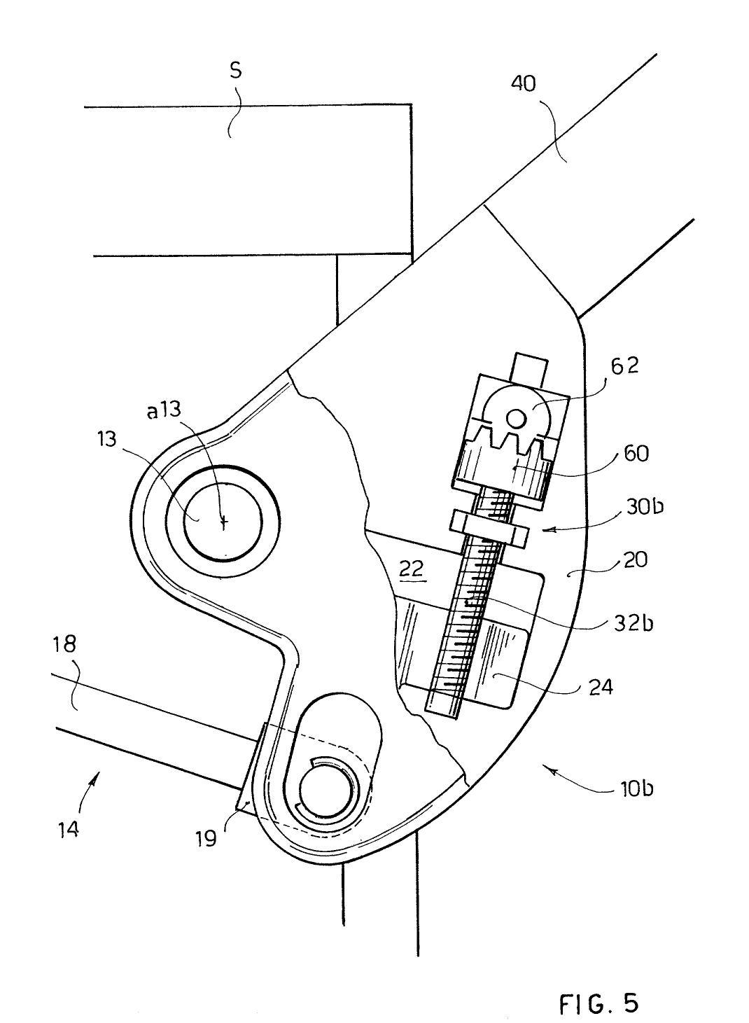

FIG. 6 shows an embodiment for hinged doors in a similar view to that of FIG. 2;

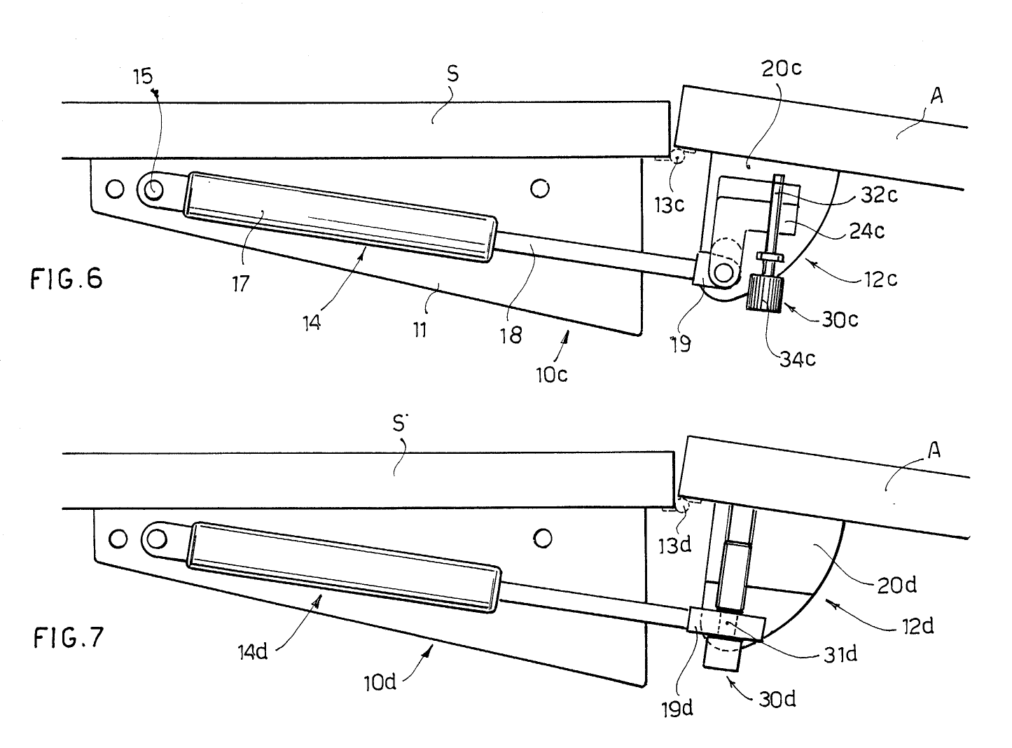

FIG. 7 shows an embodiment of the device for hinged doors with adjustment on a head of the gas spring.

FIG. 1 has been described above with reference to the state of the art.

A new door movement device is designated as a whole by the reference 10 in FIG. 2, where in reference S is a stationary structure of a piece of furniture and A is a movable door thereof. On a base plate 11, the new device comprises a first articulation element 12 and a second articulation element 14 in the form of links or connecting rods. The first element 12 is pivoted in a fixed point or fulcrum 13 on plate 11. The connecting-rod element 12 and connecting-rod element 14 are hinged together on a movable hinge 16. Element 14 comprises or is made up of a spring, preferably a gas spring or gas-controlled spring, which comprises a cylinder 17, a stem 18 slidable with respect to the cylinder and terminating in a head designated by 19. Axis a16 of hinge 16 can thus rotate about axis a13 of fulcrum 13 and simultaneously about axis a15 of fulcrum 15, as the stem 18 is retracted within the cylinder 17. The extracted end position, shown in FIG. 2, is a stable position; the retracted end position (dashed line) is also a stable position, whilst the intermediate positions are unstable positions.

According to the invention, the connecting-rod element 12 comprises a casing, as appears more clearly from FIG. 3, designated by the reference number 20. The casing forms an internal housing 22 which houses a pawl 24 movable inside it. The pawl 24 has a pivot axis a16 for head 19. The casing 20 has a through hole 26, and the pawl 24 has a threaded hole 28 aligned with the hole 26. An adjusting means 30, in the example of FIG. 3, comprises a threaded adjusting stem 32 and a manoeuvring knob 34. The stem 32 enters the hole 26 and engages the threaded hole 28. The casing 20 is preferably covered with a cover (not shown).

Adjustment of the position of pawl 24 within the housing 22 by the means 30 enables variation of the distance between axis a13 and axis a16, thus varying the lever arm with which the spring acts on the connecting rod 12.

FIG. 3 shows with a dashed line and a solid line, respectively, the two adjustment end positions for head 19. The axis of the retracted position, or of the minimum lever arm (dashed line), is designated by a′16. The axis of the extended position, or of the maximum lever arm, is designated by a16. According to a preferred embodiment of the invention, the traces on the plane of the figure of the axes a16, a′16 are on same arc of circumference having centre a15; i.e., the portion a16-a′16 is a chord of said circumference.

In the exemplary embodiment shown in FIGS. 2 and 3, the connecting-rod element 12 is integral with an arm 40 of an articulated parallelogram, which comprises a further arm 42. The arm 40 is pivoted in 41 to a plate 43 fixed to door A, whilst the arm 42 is pivoted to the same plate in 44 and to the plate 11 of the stationary structure in 45. The reference numbers 46 designate fixing means for fixing the plate 11 on the stationary structure S.

FIG. 3a shows the opposite face of the device to the one shown in FIG. 3. Preferably an indicator means, designated as a whole by 50, is provided, which comprises, in register with threaded stem 32, a slot 51 within which a pin 52 extends fixed to the stem 32. A graduated scale 53 enables to read the position of the pin 52 in the slot 51 and hence the adjustment that is being made to the position of the head 19 of the stem of the spring.

FIG. 4 shows a variant 10a of the embodiment of FIG. 3. The same references are used for the parts that remain unvaried; these will not be described further herein. In the embodiment of FIG. 4, threaded stem 32a of adjustment means 30a is fixed to a bevel pinion 55, which engages a further bevel pinion 56 whose axis is perpendicular to the axis of the stem 32. The pinion 56 is accessible from outside.

In a variant 10b of the device, shown in FIG. 5, the same reference numbers are used as in FIG. 3 for identical items, which will not be described further herein. In FIG. 5, adjusting means 30b comprises a ring-gear head 60, which can be operated with an engagement means (not shown) introduced through a hole 62 in the casing.

A variant 10c of the device shown in FIG. 6, is particularly suited for hinged doors. A hinge between door A and structure S is referenced 13c. In this case, the casing 20c is fixed directly to door A and is rigid with the latter. The first connecting-rod element 12c is made up of a combination of casing 20c and door A. In practice, hinge 13c is equivalent to the fulcrum indicated by 13 for the above described devices. Adjusting stem 32c acts on pawl 24c and has manoeuvring knob 34c set at the bottom instead of in the top position.

In a device 10d shown in FIG. 7, casing 20d is rigid (in a way similar to the embodiment of FIG. 6) with respect to a door A, and the latter is hinged to structure S on fulcrum 13d. The regulating means 30d is screwed directly in the casing and has a neck 31d for engaging a head 19d of gas spring 14d. The head 19d in this case has a through hole. In this way, adjusting can be performed directly on the head of the gas spring.

Additional embodiments are possible without, however, thereby departing from the scope of the present invention.

1. A movement device for pieces of furniture, for articulating a door with respect to a stationary structure, comprising a first articulation element (12; 12a . . . ) linked to the door and pivotable with respect to the stationary structure, a second articulation element (14) hinged to the stationary structure, the ends of said two articulation elements being hinged together, the first articulation element having an elastically variable extension, so that said two elements may assume, with respect to one another, a stable retracted position and a stable extended position passing through a succession of unstable positions, characterized in that it comprises adjustment means (30; 30a; 30b . . . ) for adjusting a distance between an axis (a16) of a hinge between the two elements and a rotation or pivotal axis (a13) of the second element with respect to the stationary structure.

2. A device according to claim 1, characterized in that said adjusting means vary a position of the hinge (16) axis along a line belonging to a chord of a circumference having as its axis the axis (a15) of the fulcrum of the second articulation element.

3. A device according to claim 1, characterized in that said first articulation element (12) comprises a casing (20) with an internal housing (22); a pawl (24) movable for a length within said housing (22), and having said hinge (16) for the other element; and in addition, an adjusting means (30) engaging said pawl for displacing the same.

4. A device according to claim 3, characterized in that the adjusting means (30) comprises a threaded stem (32) and a manoeuvring means (34), whilst said pawl has a threaded hole.

5. A device according to claim 4, characterized in that the manoeuvring means is one of the following: a manoeuvring knob, a bevel gear pair, a ring-gear manoeuvring head.

6. A device according to claim 1, characterized in that said first element comprises a casing fixed to said door, and said door is hinged to the stationary structure, said casing comprising a housing, and said adjusting means comprising a pawl in said housing provided with a threaded hole, and an adjusting means for adjusting the position of the pawl in the housing.

7. A device according to claim 1, characterized in that said first element (12d) comprises a casing, a threaded hole in the casing, an adjusting means (30d) with a threaded stem engaged in said threaded hole, said adjusting means being engaged with a head (19d) of the second element (14d).
